(19) United States
(12) Patent Application Publication
(10) Pub. No.: US 2004/0171315 A1
(43) Pub. Date: Sep. 2, 2004

(54) Joint structure of electronic element

(75) Inventors: Pei-Sheng Liao, Zungli City (TW); Jui-Yuan Hsu, Zungli City (TW); Bay Shao-Ru Su, Zungli City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics Inc., Taoyuan Shien (TW)

(21) Appl. No.: 10/746,192

(22) Filed: Dec. 26, 2003

(30) Foreign Application Priority Data
Dec. 25, 2002 (TW) 091137369

(51) Int. Cl. H01R 13/42

(52) U.S. Cl. 439/751

(57) ABSTRACT

A joint structure of electronic element for linking circuit board and electronic element is provided. The joint structure of an electronic element for being electrically connected to a circuit board has at least one slot positioned thereon. And, the joint structure of the electronic element includes: at least one terminal which has a curved portion including a deflected angle with a normal line of a plane of the circuit board, wherein when the joint structure of the electronic element is connected with the slot, the terminal produces an elastic stress through suffering a jostle from the slot so as to urge against the slot for forming an electrical connection therebetween.

### FIELD OF THE INVENTION

The present invention is related to a joint structure of electronic element for linking circuit board and electrical element, and more particularly, to a joint structure of electronic element which has features of elasticity, selectivity and is capable of fabricating an electronic element and a circuit board without tools. When the electrical element is connected with circuit board, the terminal of the electronic element and the circuit board will be electrically connected.

### BACKGROUND OF THE INVENTION

While Electronic products are getting more complex, the number of electrical elements on the circuit board is increased in these several years. That is why there are a lot of electrical elements on the general circuit boards. Take mother board as an example, there are all kinds of elements of mounted on it, including chips, resistors, capacitances and slots. For slot, it is used for inserting all sorts of electronic card such as memory card, vision card and sound card or any card for inputting and outputting power source.

In general, in order to obtain the biggest expansion for the computer, the computer manufacturer usually welds all sorts of expansion slots (or connectors) on the mother board so that the client can insert more control cards and electrical elements whenever needed. But, most computer users are common families not professional users, so they only need a few slots in the beginning period. After a few time later, when the users want to increase the new electrical elements (for example: control card), the unused expansion slot will be used. However, most general users upgrade computers rarely and the unused expansion slots are wasted and the cost of the computers is increased.

Please refer to FIG. 1. FIG. 1 illustrates the connecting structure of the electrical terminal and the circuit board. The structure includes the terminal 101 of the electrical element 100. The terminal 101 is electrically connected with the rejecting part 104 of the circuit board 103 by soldering tin 102. In this kind of manufacturing process, usually the electrical element 100 is inserted into the circuit board 103 by auto-machine (not show in the drawing). Then, the circuit board 103 is passed through the soldering pot so as to connect the rejecting part 104 and the terminal 101 through the soldering tin 102 by the capillarity between the terminal 101 and the rejecting part 104. Here the electrical element 100 could be seen as a connector. Only a few necessary slots are set on the mother board and not all connectors are welded on the mother board. In theory, the users can weld the electrical element 100 by hand to increase new connectors on the mother board when they want to increase the number of connector. However, most of them don't have relevant tools, even they have, they still can't operate the welding well like the professionals do, and the slot or mother board might be unavoidably damaged. Furthermore, since the present electrical elements usually have plural terminals and the distance between the terminals is getting smaller, the welding by hand is more difficult.

Please refer to FIG. 2. FIG. 2 is a schematic view showing another connection between the terminal and the circuit board according to prior art t. The structure includes the terminal 201. The terminal 201 has an arrow-like shape, which is enlarged from bottom to middle for forming the fixing part 202 having a width A. This kind of conventional terminal 201 is used in some handheld electronic products like mobile phones. Since small volume is one of the purposes for mobile phone, the density of the electrical elements is usually high. In addition, in order to manufacture fast, the terminal 201 is pressed into the fixing hole 204 of the rejecting part 203 by the special machine (not show in this drawing). This kind of electronic products are mostly consumptive and the electrical elements need not to be detached so the width B of the fixing hole 204 is wider than the width A. When the terminal 201 is pressed into the fixing hole 204, the limit of the width B will make the width A have a shape change (plasticity changing), so as to ensure that the connection between the fixing hole 204 and the terminal 201 will not loose by light impact. In other words, the terminal 201 has the functions of transmitting signals and power source and supporting the electrical element 200 so as to guarantee that the fixing hole 204 and the terminal 201 will not be separated easily.

However, the conventional structure shown in FIG. 2 is used in communication industry only at the present time. Inserting the terminal 201 into the fixing hole 204 completely has to be accomplished only by special tools that provide enough force and common people can't do it by themselves. Through test we can realize it needs 2 to 4.5 kg to insert one single terminal 201 into the fixing hole 204. In general, there are ten to forty terminals on the slot. In another words, we need 20 to 180 kg to set a slot on the mother board, which is likely impossible to accomplish by hand. Moreover, common families will not buy the tools only for increasing the slots and the sellers will not provide the tools for free. Besides, the terminal 201 has a lot of functions and needs to be avoided the bending of the terminal 201, so the material of the terminal 201 needs to be choose carefully and the cost is high (about 40 dollars).

Please refer to FIGS. 3(a) and (b). FIGS. 3(a) and (b) illustrate a general connector connected with a circuit board. The connector 300 is welded and fixed on the slot 302 of the circuit board 301 by soldering tin (please refer to the technical contents of FIG. 1). The terminal 304 of the connector 300 is electrically connected with the circuit board 301 by soldering tin. At last, the needed circuit board 305 with different function is inserted into the circuit board 305 and fixed by the fixing element 303 (shown in FIG. 3(b)). Although there is only one connector (expansion slot) shown in the drawing, in general, in order to obtain the biggest expansion of the computer, the computer manufacture usually weld all sorts of expansion slots (or called connectors) on the mother board so that the clients can insert into more control cards and electrical elements whenever needed.

In order to overcome the drawbacks and solve the problems encountered in the prior art, an improved joint structure of electronic element is provided in the invention.

### SUMMARY OF THE INVENTION

It is therefore an object of the present invention to provide a joint structure of an electronic element for being electrically connected to a circuit board having at least one slot positioned thereon. The joint structure of the electronic element includes: at least one terminal which has a curved portion including a deflected angle with a normal line of a plane of the circuit board, wherein when the joint structure of the electronic element is connected with the slot, the terminal produces an elastic stress through suffering a jostle from the slot so as to urge against the slot for forming an electrical connection therebetween.

Preferably, the terminal includes two pieces which from an adjustable space therebetween and each of which is bent toward the adjustable space for forming a force-receiving surface and a protruding part, and when the joint structure of the electronic element is connected to the circuit board, because the force-receiving surface is pushed by the slot the two pieces approach each other so as to reduce the adjustable space.

Preferably, the joint structure of electronic element further comprising a bridge which combines the two pieces so that when the two pieces are plugged into the slot so as to approach the two pieces to each other through a compression, and the bridge is elastically deformed and when the two pieces are unplugged from the slot, the two pieces are then opened again through an the elasticity of the bridge.

Preferably, the slot is a slender one so that the terminal is movable along the slender slot.

Preferably, the joint structure further includes a first fixing element and the circuit board further includes a second fixing component, and the first fixing component and the second fixing component are fixed to each other.

Preferably, the electronic element further includes a first positioning piece and the circuit board further includes a second positioning piece, and the first positioning piece is matched with the second positioning piece so as to position the terminal at the slot.

Preferably, the first positioning piece is positioned on the first fixing component and the second fixing component is used as the second positioning piece.

Preferably, the first positioning piece is a pin and the second positioning piece is a pinhole, and when the first positioning piece is matched with the second positioning piece, the pin is plugged into the pinhole.

Preferably, the first positioning piece is a guide rail and the second positioning piece is a guide bar, and when the first positioning piece is matched with the second positioning piece, the guide bar is placed into the guide rail.

Preferably, the second fixing component is a fixing groove for containing the first fixing component therein and the second fixing component further includes an opening for jamming therein the circuit board.

Preferably, after the opening is jammed by the circuit board, a card is plugged into the fixing groove for preventing the circuit board from escaping from the opening.

Preferably, the electronic element is a voltage regulation module.

Preferably, the circuit board is a computer motherboard.

Preferably, the joint structure further includes a first fixing component and a third fixing component and the circuit board includes a second fixing component and the first fixing component and the second fixing component are loose fitted to each other and become to be close fitted to each other because the third fixing component further opens the first fixing component.

Preferably, the second fixing component is an inserted hole.

Preferably, the first fixing component is an inserting pin, and the inserting pin and the joint structure are formed integrally.

Preferably, the third fixed component is a plug for further opening the inserting pin elastically so as to urge the inserting pin tightly against the hole.

Preferably, the first fixing component and the second fixing component are formed to be a locking pin.

Preferably, the joint structure of the electronic element is a connector.

It is another object of the present invention to provide a joint structure of an electronic element for linking a circuit board which has at least one slot positioned thereon. The joint structure of the electronic element includes: at least one terminal which has a deflected angle with a normal line of a plane of the circuit board so as to from a protruding part, when the joint structure of the electronic element is connected with the slot, the protruding part produces an elastic stress through suffering a jostle from the slot for forming an electrical connection therebetween.

The foregoing and other features and advantages of the present invention will be more clearly understood through the following descriptions with reference to the drawings, wherein:

### BRIEF DESCRIPTION OF THE DRAWINGS

FIG. 1 is a schematic view showing a connection between the terminal and the circuit board according to prior art;

FIG. 2 is a schematic view showing another connection between the terminal and the circuit board according to prior art;

FIG. 3 is a schematic view showing another connection between the connector and the circuit board according to prior art;

FIG. 4 is a schematic view showing a joint structure of electronic element according to a preferred embodiment of the present invention;

FIGS. 5(a) and (b) are schematic views showing joint structures of electronic element according to another preferred embodiment of the present invention;

FIGS. 6(a) and (b) are schematic views showing joint structures of electronic element according to another preferred embodiment of the present invention;

FIGS. 7(a), (b) and (c) are schematic views showing joint structures of electronic element according to another preferred embodiment of the present invention;

FIGS. 8(a) and (b) are schematic view showing joint structure of electronic element according to another preferred embodiment of the present invention; and

FIGS. 9(a) and (b) are a schematic view showing a joint structure of electronic element according to another preferred embodiment of the present invention; and

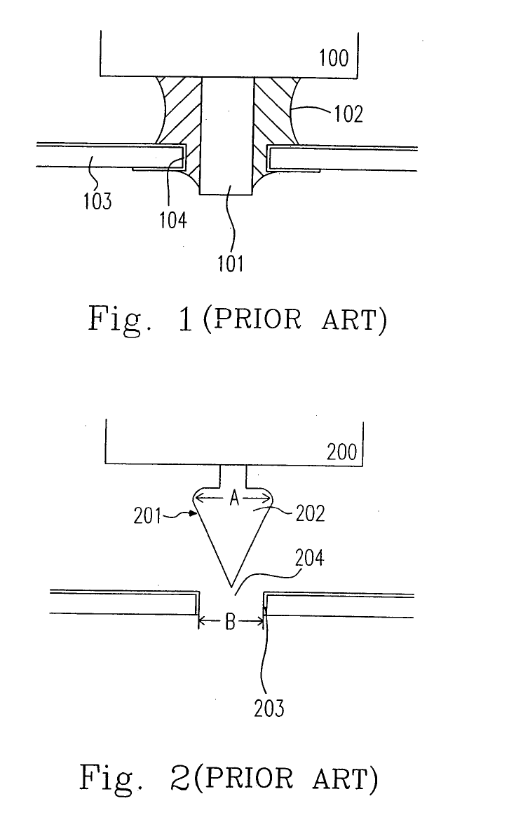

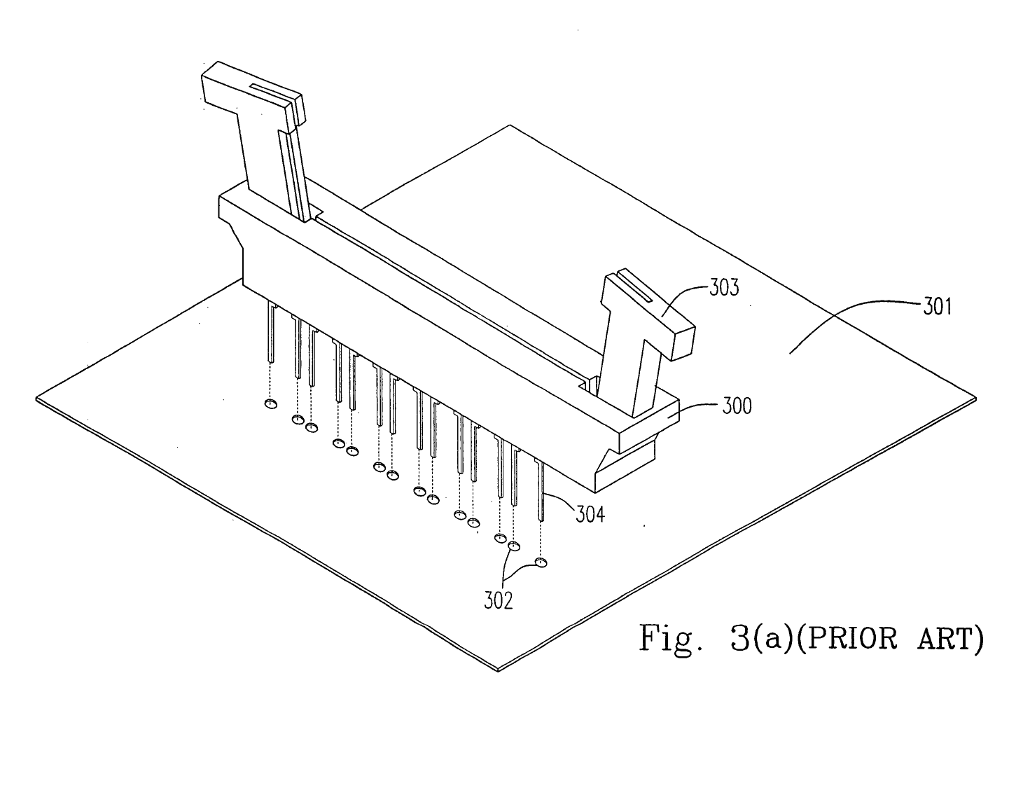

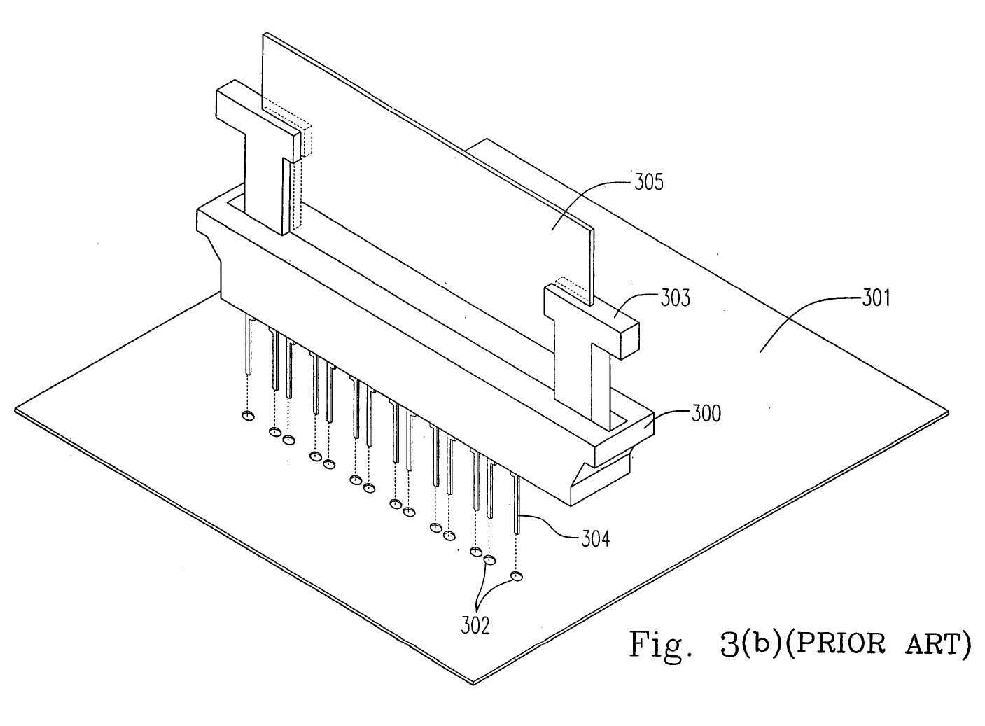

### DETAILED DESCRIPTION OF THE PREFERRED EMBODIMENT

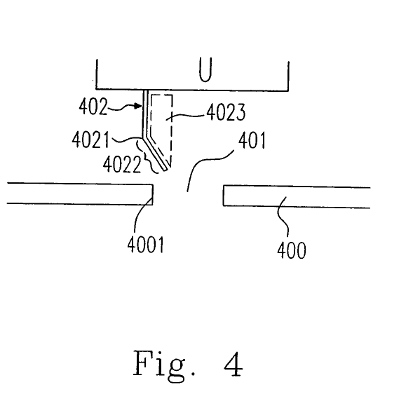

The present invention will now be described more specifically with reference to the following embodiments. Please refer to FIG. 4. FIG. 4 is a joint structure of electronic element according to a preferred embodiment of the present invention. The circuit board 400 has the slot 401 mounted thereon. The metal terminal 402 is inserted into the slot 401 and is electrically connected with the slot wall 4001 of the slot 401 through the protruding part 4021, as shown in the FIG. 4. The metal terminal 402 further includes the force-receiving surface 4022 which forms the adjustable space 4023. When the metal terminal 402 is inserted into the slot 401, the force-receiving 4022 will be pushed against the slot wall 4001 so that the terminal 402 is elastically deformed to urge against the center of the slot 401. Meanwhile, since the metal terminal 402 is made of elastic metal, an elastic stress will be produced to allow the protruding part 4021 of the terminal 402 rejected against the slot wall 4001. Hence, the protruding part 4021 is electrically connected to the slot wall 4001 stably by this elastic stress.

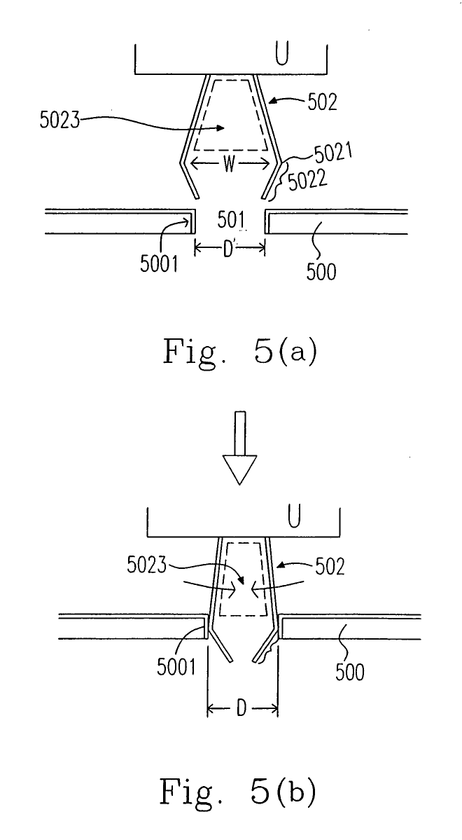

Please refer to FIG. 5. FIGS. 5(a) and (b) are joint structures of electronic element according to another preferred embodiment of the present invention. This embodiment is changed from the embodiment shown in FIG. 4. There are two bar terminals 502 which form the adjustable space 5023. The two terminals 502 bend to each other, which form two protruding parts 5021. The width between the two protruding parts 5021 is W and the two terminals 502 have force-receiving surfaces 5022 respectively. When the two terminals 502 are inserted into the slot 501, the force-receiving surface 5022 is pushed against the slot 501, and the two terminals approach to each other so as to decrease the adjustable space 5023. For this reason, the width between the two protruding parts 5021 will be the same with the width D of the slot 501 at this time, due to the width limit of the slot wall 501. When the user allows the terminal 502 detached from the slot 501, the limit from the slot 501 disappears and the two terminals 502 will return to their original shapes by their elasticity. Therefore, the width of two protruding parts 5021 will return to W.

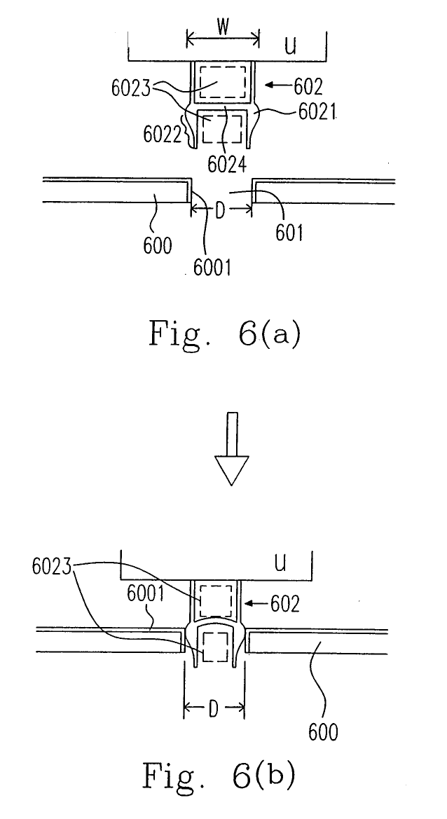

Please refer to FIGS. 6(a) and (b). FIGS. 6(a) and (b) are joint structures of electronic element according to another preferred embodiment of the present invention. This embodiment shown in FIG. 6 is changed from the embodiment shown in FIG. 5. The two terminals 602 form the adjustable space 6023 in the center therebetween and the two terminals 602 are connected to each other by the bridge 6024. Otherwise, the two terminals 602 form the force-receiving surface 6022 and the protruding part 6021. The bridge 6024 is elastic and when the terminal 602 is inserted into the slot 601, the protruding part 6021 is pushed against the slot wall 6001 to let the width W the same with the width D of the slot 601. Therefore, the bridge 6024 is elastically deformed at this time. When the two mental terminals 602 are detached from the slot 601, the bridge 6024 will return to original shape due to its elasticity. The protruding part 6021 will not be limited by the slot wall 6001 and the width of the protruding part 6021 will return to original width W.

According to the preferred embodiment of the invention, the circuit board shown in FIG. 4, FIGS. 5(a) and (b), and FIGS. 6(a) and (b) are the same circuit board or mother board with the one in prior art. Thus, there is no need to design new circuit board particularly for the joint structure provided in the invention. The general one will be workable well.

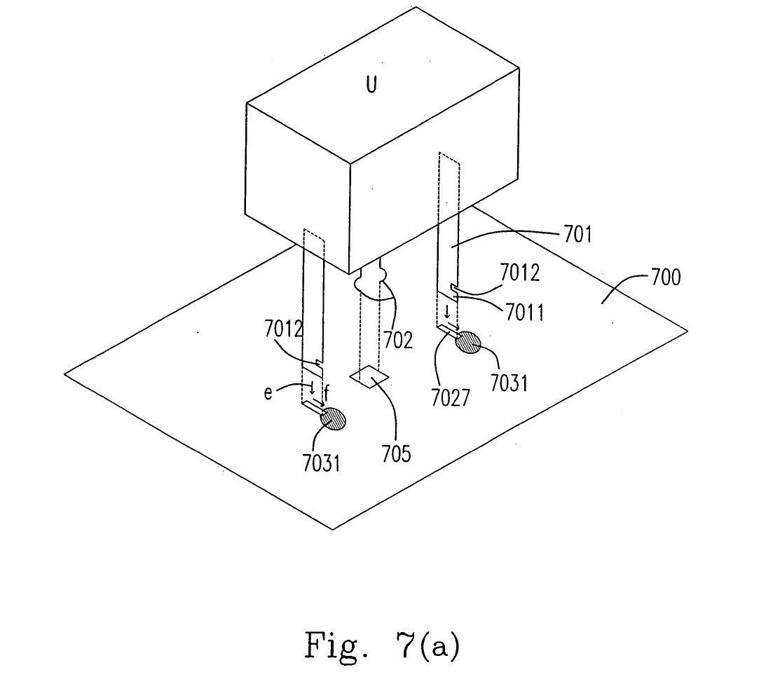

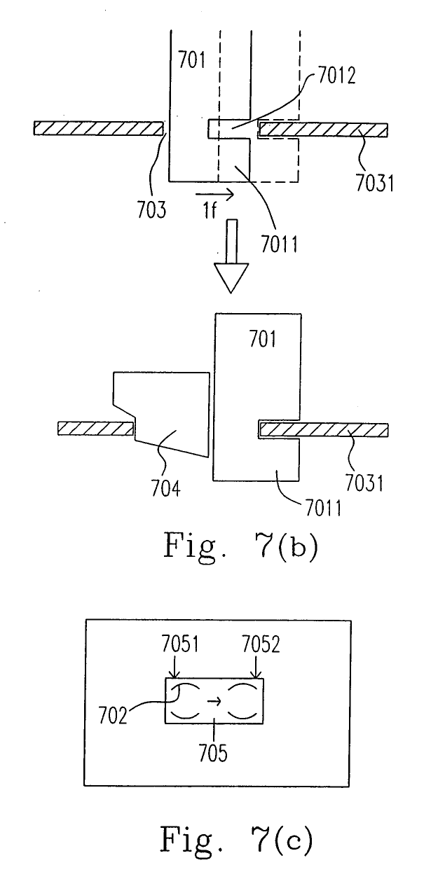

Please refer FIGS. 7(a), (b) and (c). FIGS. 7(a), (b) and (c) are another embodiment of the present invention. FIG. 7(a) is a three-dimension diagram illustrating the connection between the fixing component and the circuit board. And FIGS. 7(b) and (c) are partial enlarged ones of the first fixing component 701 and the circuit board 700. The electronic element U moves toward direction e so that the first positioning piece 7011 extended from the fixing component 701 is matched with the second positioning piece 703. For this reason the first positioning piece 7011 can move along the direction e and is inserted into the second positioning piece 703 (which is equal to the second fixing component) without shaking. When the opening 7021 is matched with the position of the circuit board 700 and the electronic element U moves toward direction f, the opening 7012 moves toward the circuit board 700 so as to allow the Opening 7021 and the circuit board 700 engaged with each other. That is, the second fixing component 7031 is jammed within the opening 7021. Through the engagement between the opening 7012 and circuit board 700, the electronic element U gets engaged with the circuit board 700 so as to solve the problem that the single engagement between the terminal 702 and the circuit board 700 might not be tight enough. In order to ensure the opening 7012 will not get loose from the circuit board 700, the card 704 can be plugged into the fixing groove 7027 to fix the first position piece 7011 (FIG. 7(b)).

According to a preferred embodiment of the present invention, the slot 705 is a slender slot, as shown in FIG. 7(c). For matching the embodiment of FIG. 7(a), when the first positioning piece 7011 was jammed with the second positioning piece 703, the terminal 702 is inserted into the first position 7051 of the slot 705 first (reference FIG. 7(a)). Then, the first positioning piece 7011 moves horizontally and the opening 7021 was jammed with the circuit board 700 (FIG. 7(a)). In the meantime, the terminal 702 could is inserted into the second position 7052 of the slot 705.

The terminal shown in FIGS. 7(a) and (c) are two pieces the same with the terminal 502 shown in FIGS. 5(a) and (b) and the terminal 602 shown in FIGS. 6(a) and (b). The terminal 402 is one piece without fixing ability and even the two piece terminals don't have enough force, and that is why there is the need to have the first fixing component 701 and the second positioning piece 703 to help the electronic element U get fixed on the circuit board 700.

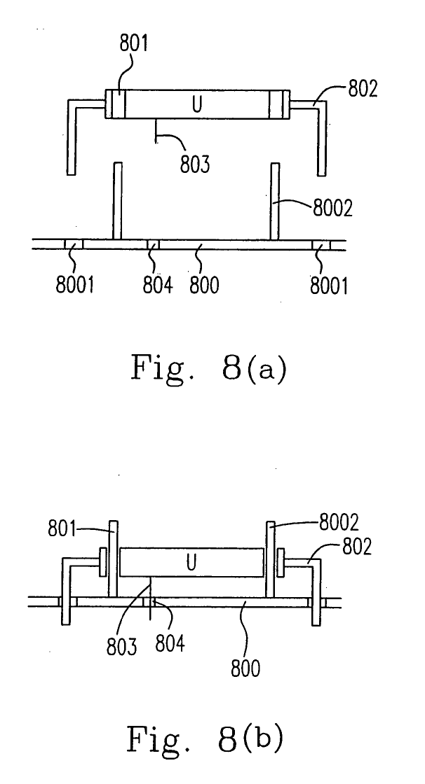

FIGS. 8(a) and (b) show another kind of situation when the electronic element U is connected with the circuit board 800. The first positioning piece is the slot 801 mounted on the electronic element U, while the second positioning piece is the piece 8002 mounted on the circuit board 800. When the slot 801 is matched with the piece 8002, the inserting pin 803 can approach to the circuit board 800 stably without shaking. The first fixing component 802 will be jammed with the second fixing component 8001. The inserting pin 803 (Referring to FIGS. 4-6) will be electrically connected with the slot wall of the slot 804 to complete the connecting action between the electronic element U and the circuit board 800.

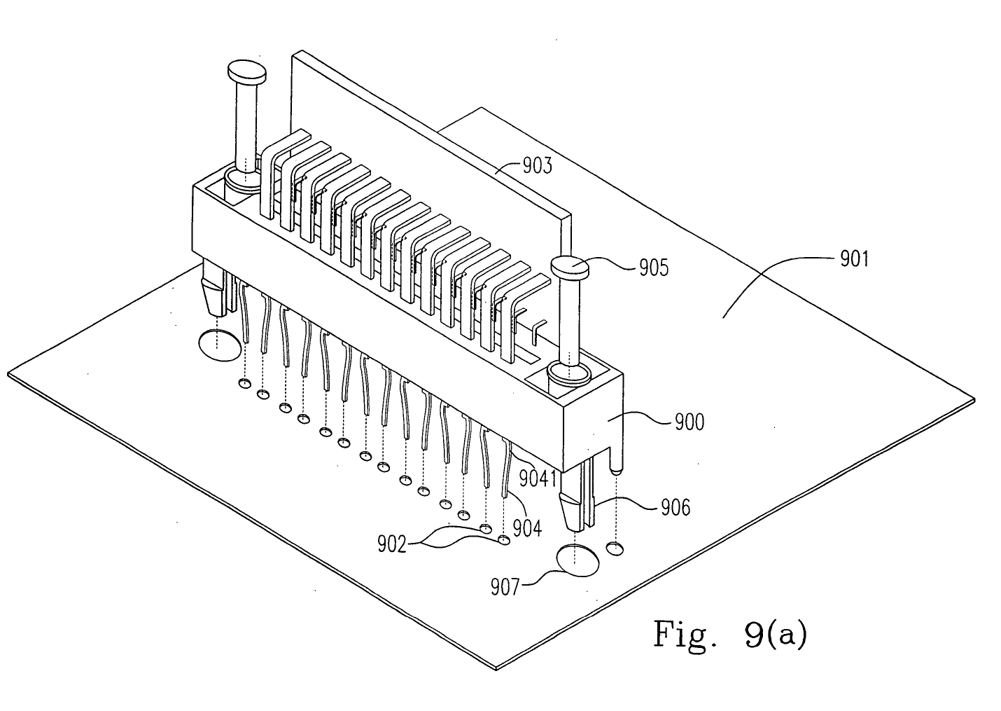

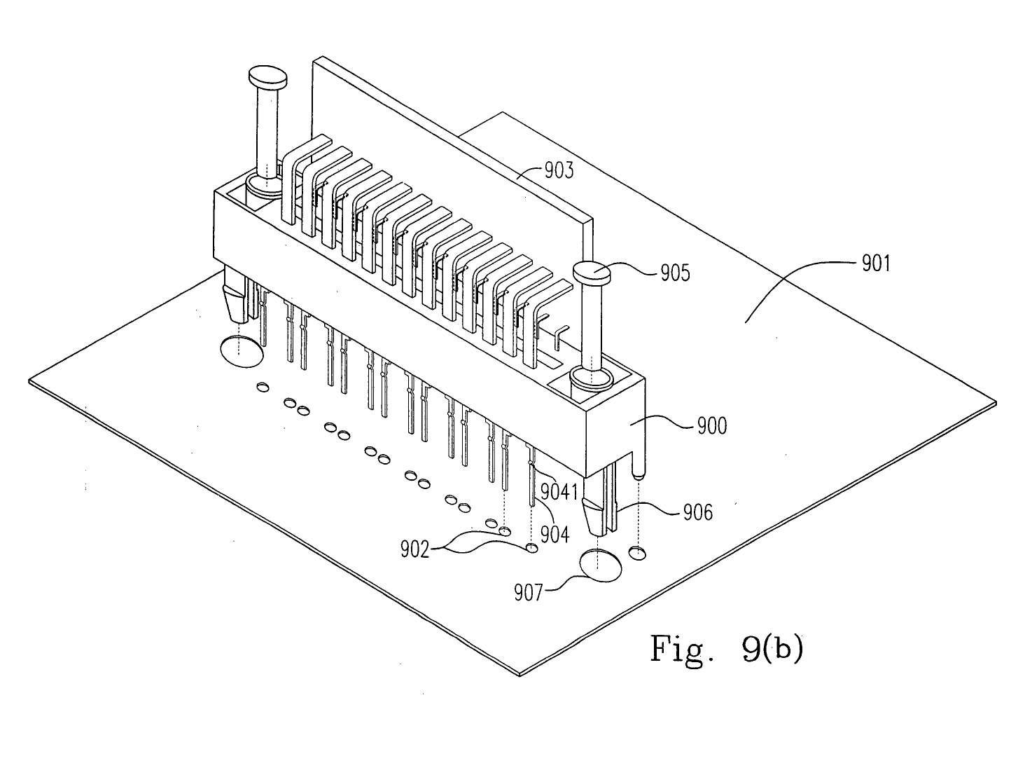

Please refer to FIG. 9. FIG. 9(a) illustrates another preferred embodiment of the present invention. As shown in FIG. 9(a), the joint structure of the electronic element 900 is connected with the circuit board 901. There is at least one slot 902 mounted on the circuit board 901. The joint structure of electronic element 900 includes the electronic element 903 which has a plurality of terminals 904. The terminals 904 have deflected angles with a normal line of a plane of the slot 902 of the circuit board so as to form the protruding part 9041. When the joint structure of electronic element 900 is connected with the slot 902, the terminal 904 will receive a positive force from the slot wall to let the terminal 904 produce an elastic force to urge against the slot 902 so as to be electrically connected therewith. And the elastic force could be adjusted according to different measures of the electronic elements by changing the deflected angle.

However, the joint structure of electronic element 900 is fixed with the circuit board 901 through the engagement among the first fixing component 906 of the joint structure of electronic element 900, the third fixing component 905, and the second fixing component 907 of the circuit board 901. The first fixing component 906 is an inserting pin. The joint structure of electronic element 900 and the inserting pin 906 are formed integrally. The second fixing component is an inserting hole and the third fixing component 905 is a plug.

The manufacturing process is as follows. First, the joint structure 900 is mounted on the circuit board 901. The terminal 904 is matched with the slot 902 so that the terminal 904 receives a positive force from the slot wall to produce an elastic force from the terminal 904. The terminal 94 is jammed against the slot 902 so as to be electrically connected therewith. Therefore, there is no need to use soldering tin to weld the terminal 904 and the circuit board 901. At this time, the first fixing component 906 is inserted into the second fixing component 907 so as to allow the first fixing component 906 and the second fixing component loose fitted to each other. In order to allow the joint structure 900 fixed on the circuit board 901 completely, the third fixing component 905 is pressed into the hole of the first fixing component 906. Then, the first fixing component 906 is opened by elasticity and the first fixing component 906 and the third component 907 will be tightly fitted. Hence, the joint structure 900 will be fixed on the circuit board 901 completely.

Form the content of above description, we can realize that the fabricating of the electrical element and circuit board can be accomplished without any tools according to the disclosure of the present invention. For the industry's need, the electrical element and the circuit board are connected with each other completely and the electrical connection is accomplished at the time when the fabrication is finished. Further, the present invention doesn't need the welding step to ensure the electrical connection. And more particularly, the joint structure of electrical element has the features of elasticity, selectivity and is capable of fabricating an electrical element and a circuit board without tools.

Furthermore, the present invention provides the joint structure of electrical element, which allows the computer manufacturer needn't weld all electrical elements on the mother board. And the users could add slots or connectors whenever needed in the future. Therefore, the cost for mother board is reduced. In addition, the joint structure of electrical element for lining circuit board and electrical element is capable of mounting many electrical elements thereon.

FIG. 9(b) is another preferred embodiment of the present invention according to the seventh embodiment. The theory of FIG. 9(b) is the same with FIG. 9(a) according to sixth embodiment and it's a variation of the sixth embodiment that the shapes of the terminals 904 are slightly changed.

The joint structure of electrical element in the above description could be a connector, for example an expansive slot for computer memory. The electrical element in the above description could be a voltage regulator module. And the circuit board in the above description could be a mother board.

In sum, the present invention has an industry utility since it has the characteristics of connecting electrical element with circuit board completely without any tools. More importantly, the electrical connection can be accomplished without welding step, which is an advance breakthrough.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A joint structure of an electronic element for being electrically connected to a circuit board having at least one slot positioned thereon, said joint structure of said electronic element comprising:
at least one terminal which has a curved portion including a deflected angle with a normal line of a plane of said circuit board, wherein when said joint structure of said electronic element is connected with said slot, said terminal produces an elastic stress through suffering a jostle from said slot so as to urge against said slot for forming an electrical connection therebetween.

2. The joint structure of electronic element according to claim 1 wherein said terminal comprises two pieces which from an adjustable space therebetween and each of which is bent toward said adjustable space for forming a force-receiving surface and a protruding part, and when said joint structure of said electronic element is connected to said circuit board, because said force-receiving surface is pushed by said slot, said two pieces approach each other so as to reduce said adjustable space.

3. The joint structure of electronic element according to claim 2 further comprising a bridge which combines said two pieces so that when said two pieces are plugged into said slot so as to approach said two pieces to each other through a compression, and said bridge is elastically deformed and when said two pieces are unplugged from said slot, said two pieces are then opened again through an the elasticity of said bridge.

4. The joint structure of electronic element according to claim 1 wherein said slot is a slender one so that said terminal is movable along said slender slot.

5. The joint structure of electronic element according to claim 1 wherein said joint structure further comprises a first fixing element and said circuit board further comprises a second fixing component, and said first fixing component and said second fixing component are fixed to each other.

6. The joint structure of electronic element according to claim 5 wherein said electronic element further comprises a first positioning piece and said circuit board further comprises a second positioning piece, and said first positioning piece is matched with said second positioning piece so as to position said terminal at said slot.

7. The joint structure of electronic element according to claim 6 wherein said first positioning piece is positioned on said first fixing component and said second fixing component is used as said second positioning piece.

8. The joint structure of electronic element according to claim 6 wherein said first positioning piece is a pin and said second positioning piece is a pinhole, and when said first positioning piece is matched with said second positioning piece, said pin is plugged into said pinhole.

9. The joint structure of electronic element according to claim 6 wherein said first positioning piece is a guide rail and said second positioning piece is a guide bar, and when said first positioning piece is matched with said second positioning piece, said guide bar is placed into said guide rail.

10. The joint structure of electronic element according to claim 5 wherein said second fixing component is a fixing groove for containing said first fixing component therein and said second fixing component further comprises an opening for jamming therein said circuit board.

11. The joint structure of electronic element according to claim 10 wherein after said opening is jammed by said circuit board, a card is plugged into said fixing groove for preventing said circuit board from escaping from said opening.

12. The joint structure of electronic element according to claim 1 wherein said electronic element is a voltage regulation module.

13. The joint structure of electronic element according to claim 1 wherein said circuit board is a computer motherboard.

14. The joint structure of electronic element according to claim 1 wherein said joint structure further comprises a first fixing component and a third fixing component, and said circuit board comprises a second fixing component and said first fixing component and said second fixing component are loose fitted to each other and become to be close fitted to each other because said third fixing component further opens said first fixing component.

15. The joint structure of electronic element according to claim 14 wherein said second fixing component is an inserted hole.

16. The joint structure of electronic element according to claim 15 wherein said first fixing component is an inserting pin, and said inserting pin and said joint structure are formed integrally.

17. The joint structure of electronic element according to claim 16 wherein said third fixed component is a plug for further opening said inserting pin elastically so as to urge said inserting pin tightly against said hole.

18. The joint structure of electronic element according to claim 14 wherein said first fixing component and said second fixing component are formed to be a locking pin.

19. The joint structure of electronic element according to claim 1 wherein said joint structure of said electronic element is a connector.

20. A joint structure of an electronic element for linking a circuit board which having at least one slot positioned thereon, said joint structure of said electronic element comprising:
at least one terminal which has a deflected angle with a normal line of a plane of said circuit board so as to from a protruding part, when said joint structure of said electronic element is connected with said slot, said protruding part produces an elastic stress through suffering a jostle from said slot for forming an electrical connection therebetween.
